(19) United States
(12) Patent Application Publication
(10) Pub. No.: US 2013/0141356 A1
(43) Pub. Date: Jun. 6, 2013

(54) TOUCH PANEL

(71) Applicants: Po-Sheng SHIH, Zhubei (TW); Chun-Lung HUANG, Zhubei (TW)

(72) Inventors: Po-Sheng SHIH, Zhubei (TW); Chun-Lung HUANG, Zhubei (TW)

(73) Assignee: Shih Hua Technology Ltd., Zhubei City (TW)

(21) Appl. No.: 13/591,858

(22) Filed: Aug. 22, 2012

(30) Foreign Application Priority Data
Dec. 6, 2011 (TW) 100144764

(51) Int. Cl. G06F 3/041

(52) U.S. Cl. 345/173

(57) ABSTRACT

A touch panel includes: a substrate; a transparent conductive layer located on a surface of the substrate; a number of sensing electrodes electrically connected with the transparent conductive layer and spaced from each other. The touch panel comprises a touch-view area and a trace area. A conductive trace located on the trace area, for transmitting an electrical signal between the transparent conductive layer and an external controller. The touch-view area includes at least one first touch-view area, the number of the plurality of sensing electrodes in per unit area located on the at least one first touch-view area is greater than the number of the plurality of sensing electrodes in per unit area located on the rest of the touch-view area.

### RELATED APPLICATIONS

This application claims all benefits accruing under 35 U.S.C. §119 from Taiwan Patent Application No. 100144764, filed on Dec. 6, 2011 in the Taiwan Intellectual Property Office, the disclosure of which is incorporated herein by reference.

### BACKGROUND

1. Technical Field

The present application relates to a touch panel.

2. Discussion of Related Art

In recent years, various electronic apparatuses such as mobile phones, car navigation systems have advanced toward high performance and diversification. There is continuous growth in the number of electronic apparatuses equipped with optically transparent touch panels in front of their display devices such as liquid crystal panels. A user of such electronic apparatus operates it by pressing a touch panel with a finger or a stylus while visually observing the display device through the touch panel. Thus a demand exists for such touch panels which is superior in visibility and more reliable. Due to a higher sensitivity, the capacitive touch panels have been widely used.

When the touch panel is in use, a high sensitivity of the touch panel is required. One method for improving the sensitivity of the touch panel is to increase and closely arrange the sensing electrodes. However, the more sensing electrodes the touch panel includes, the more conducting wire the touch panel are needed. This requires the touch panel to increase the width of the edge of the touch panel, thus the overall size of the touch panel is increased. Therefore, the touch panel cannot be applied to small and medium-size electronic devices, and limits the widespread use of the touch panel.

What is needed, therefore, is to provide a touch panel which can overcome the shortcoming described above.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view showing a structure of one embodiment of a touch panel.

FIG. 2 is a schematic, cross-sectional view, along a line II-II of the touch panel of FIG. 1.

FIG. 3 shows a scanning electron microscope (SEM) image of a carbon nanotube layer.

FIG. 4 is a schematic view showing a structure of another embodiment of a touch panel.

FIG. 5 is a schematic, cross-sectional view, along a line V-V of the touch panel of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

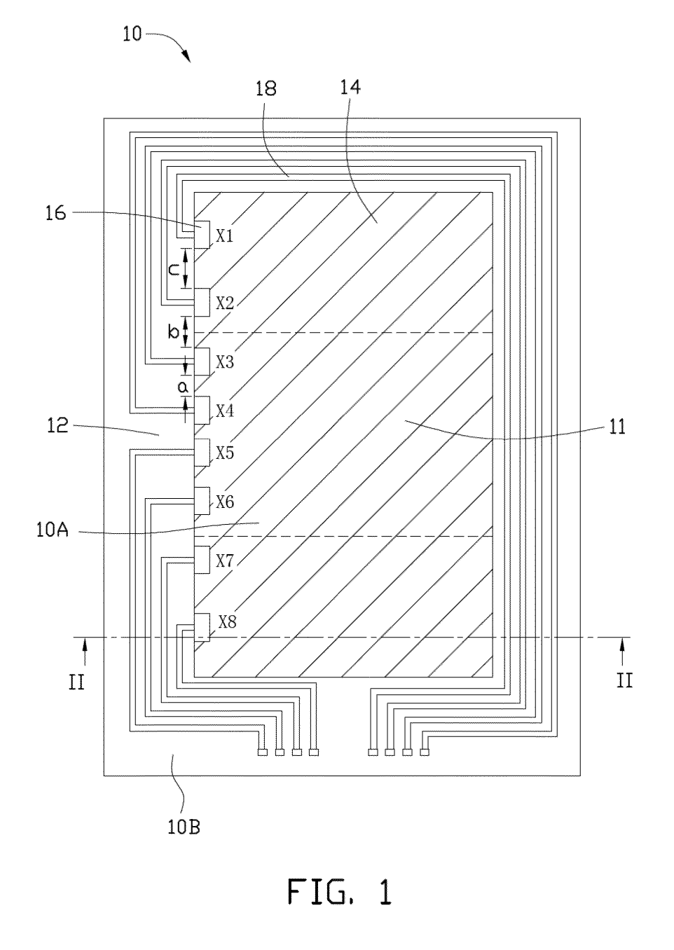

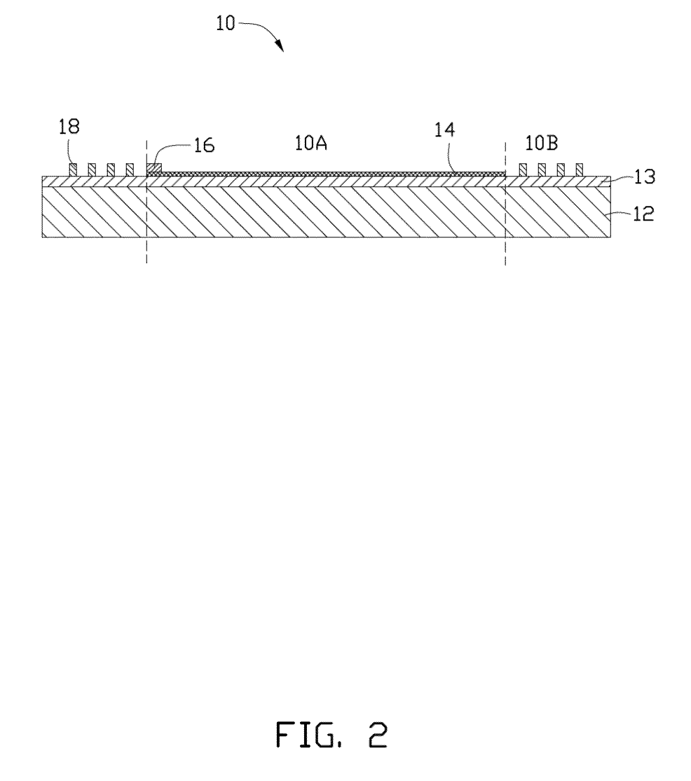

Referring to FIG. 1 and FIG. 2, one embodiment of a touch panel 10 includes a substrate 12, an adhesive layer 13, a transparent conductive layer 14, a plurality of sensing electrodes 16, and a conductive trace 18. The plurality of sensing electrodes 16 is located on a side of the transparent conductive layer 14 and spaced from each other.

The touch panel 10 defines two areas: a touch-view area 10A and a trace area 10B. The touch-view area 10A can be touched and viewed to realize the control function. The trace area 10B is usually a periphery area of the touch panel 10 which can be used to support the conductive trace 18. The touch-view area 10A has a relatively large area which includes a center area of the touch panel 10. The trace area 10B is located on at least one side of the touch-view area 10A. The positional relationship of the touch-view area 10A and the trace area 10B can be selected according to need. In one embodiment, the touch-view area 10A is the center region having a shape the same as the shape of the touch panel 10 and surrounded by the trace area 10B.

The touch-view area 10A includes at least one first touch-view area 11 and at least one second touch-view area (not labeled). The first touch-view area 11 is an area with the highest or higher usage and will be touched more times in use. The second touch-view area is an area with the lowest or lower usage and will be touched less times in use. The touch-view area 10A can have one or more first touch-view areas 11 and one or more second touch-view areas. For example, the first touch-view area 11 is located on the center region, on a top region, or on a bottom region of the touch-view area 10A. In one embodiment, the first touch-view area 11 is located on the center region of the touch-view area 10A as shown in FIG. 1.

The adhesive layer 13 is located on a surface of the substrate 12. The transparent conductive layer 14 and the conductive trace 18 are located on a surface of the adhesive layer 13. The plurality of sensing electrodes 16 is located on a surface of the transparent conductive layer 14. The transparent conductive layer 14 is located only on the touch-view area 10A. The conductive trace 18 is located only on the trace area 10B. The plurality of sensing electrodes 16 is located on a side of the transparent conductive layer 14 and electrically connected with the transparent conductive layer 14. The plurality of sensing electrodes 16 is spaced from each other. The conductive trace 18 includes a plurality of conductive wires. The number of the plurality of conductive wires is the same as the number of the plurality of sensing electrodes 16. Each of the plurality of conductive wires has a first end and a second end. The first end of each of the plurality of conductive wires is connected to one of the plurality of sensing electrodes 16. The second end of each of the plurality of conductive wires is electrically connected with an external controller (not illustrated). The transparent conductive layer 14 is electrically connected with the external controller through the conductive trace 18 and the plurality of sensing electrodes 16, in order to transmit electrical signal between the transparent conductive layer 14 and the external controller.

The adhesive layer 13 is optional. The transparent conductive layer 14, the plurality of sensing electrodes 16 and the conductive trace 18 can be located on the surface of the substrate 12 directly. The transparent conductive layer 14 has a good adhesive property, and the transparent conductive layer 14 can be directly bonded to the surface of the substrate 12 without the adhesive layer 13.

A density of the plurality of sensing electrodes 16 located on the first touch-view area 11 is greater than a density of the plurality of sensing electrodes 16 located on other areas of the touch-view area 10A. The plurality of sensing electrodes 16 is arranged along one side of the transparent conductive layer 14 and spaced from each other. A distance between the two adjacent sensing electrodes 16 away from the midline of the first touch-view area 11 is longer than a distance between the two adjacent sensing electrodes 16 close to the midline of the first touch-view area 11. The distance between the two adjacent sensing electrodes 16 increases gradually along a direction from the middle point of the side of the transparent conductive layer 14 to each end of the side of the transparent conductive layer 14.

Referring to FIG. 1, in one embodiment, there are eight sensing electrodes located on a side of the touch panel 10. The eight sensing electrodes are sequentially named as an electrode X1, an electrode X2, an electrode X3, an electrode X4, an electrode X5, an electrode X6, an electrode X7, and an electrode X8. A distance between the electrode X1 and electrode X2 is defined as c, a distance between the electrode X3 and electrode X2 is defined as b, a distance between the electrode X4 and electrode X3 is defined as a, wherein c>b>a. A distance between the electrode X6 and electrode X5 is defined as d, a distance between the electrode X7 and electrode X6 is defined as e, a distance between the electrode X8 and electrode X7 is defined as f, wherein f>e>d. In one embodiment, a=d, b=e, c=f. The number of the plurality of sensing electrodes 16 in per unit area close to the midline of the first touch-view area 11 is greater than the number of the plurality of sensing electrodes 16 in per unit area away from the midline of the first touch-view area 11. The distance should not be too large; otherwise the position of the touch point cannot be accurately detected. The distance between two adjacent sensing electrodes 16 can be in a range from about 3 millimeters to about 15 millimeters.

The substrate 12 can be flat or curved and support other elements. The substrate 12 can be insulative and transparent. The substrate 12 can be made of rigid materials such as glass, quartz, diamond, plastic or any other suitable material. The substrate 12 can also be made of flexible materials such as polycarbonate (PC), polymethyl methacrylate acrylic (PMMA), polyimide (PI), polyethylene terephthalate (PET), polyethylene (PE), polyether polysulfones (PES), polyvinyl polychloride (PVC), benzocyclobutenes (BCB), polyesters, or acrylic resin. In one embodiment, the substrate 12 is a flat and flexible PC plate.

The transparent conductive layer 14 can be a carbon nanotube layer, a conductive indium tin oxide layer, or a conductive antimony tin oxide layer.

The carbon nanotube layer includes a carbon nanotube film. The carbon nanotube film includes a plurality of carbon nanotubes. The carbon nanotube film can be a substantially pure structure of the carbon nanotubes, with few impurities and chemical functional groups. A majority of the carbon nanotubes are arranged to extend along the direction substantially parallel to the surface of the carbon nanotube film. The carbon nanotubes in the carbon nanotube film can be single-walled, double-walled, or multi-walled carbon nanotubes. The length and diameter of the carbon nanotubes can be selected according to need, for example the diameter can be in a range from about 0.5 nanometers to about 50 nanometers and the length can be in a range from about 200 nanometers to about 900 nanometers. The thickness of the carbon nanotube film can be in a range from about 0.5 nanometers to about 100 micrometers, for example in a range from about 100 nanometers to about 200 nanometers. The carbon nanotube film has a good flexibility because of the good flexibility of the carbon nanotubes therein.

The carbon nanotubes of the carbon nanotube film can be arranged orderly to form an ordered carbon nanotube structure or disorderly to form a disordered carbon nanotube structure. The term ‘disordered carbon nanotube structure’ includes, but is not limited to, to a structure where the carbon nanotubes are arranged along many different directions, and the aligning directions of the carbon nanotubes are random. The number of the carbon nanotubes arranged along each different direction can be almost the same (e.g. uniformly disordered). The carbon nanotubes in the disordered carbon nanotube structure can be entangled with each other. The term ‘ordered carbon nanotube structure’ includes, but is not limited to, to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions).

In one embodiment, the carbon nanotube film is a free-standing structure. The term “free-standing structure” means that the carbon nanotube film can sustain the weight of itself when it is hoisted by a portion thereof without any significant damage to its structural integrity. Thus, the carbon nanotube film can be suspended by two spaced supports. The free-standing carbon nanotube film can be laid on the epitaxial growth surface directly and easily.

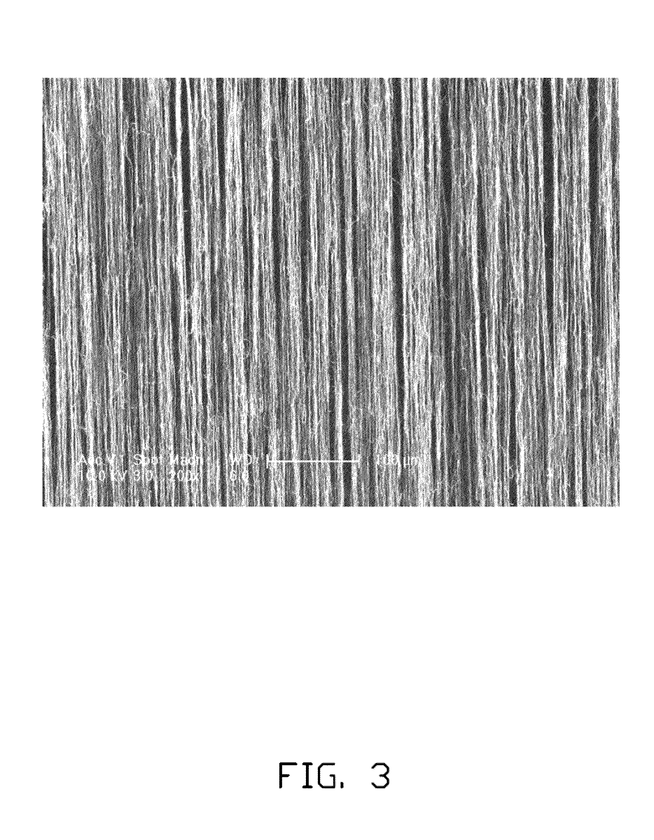

In one embodiment, the transparent conductive layer 14 is a single carbon nanotube film. The carbon nanotube film includes a plurality of successive and oriented carbon nanotubes joined end-to-end by van der Waals attractive force therebetween. The carbon nanotube film is a free-standing film. Referring to FIG. 3, each carbon nanotube film includes a plurality of successively oriented carbon nanotube segments joined end-to-end by van der Waals attractive force therebetween. Each carbon nanotube segment includes a plurality of carbon nanotubes parallel to each other, and combined by van der Waals attractive force therebetween. Some variations can occur in the carbon nanotube film. The carbon nanotubes in the carbon nanotube film are oriented along a preferred orientation. The carbon nanotube film can be treated with an organic solvent to increase the mechanical strength and toughness and reduce the coefficient of friction of the carbon nanotube film. A thickness of the carbon nanotube film can range from about 0.5 nanometers to about 100 micrometers.

The transparent conductive layer 14 can include at least two stacked carbon nanotube films. Additionally, when the carbon nanotubes in the carbon nanotube film are aligned along one preferred orientation, an angle can exist between the orientations of carbon nanotubes in adjacent films, whether stacked or adjacent. Adjacent carbon nanotube films can be combined by only the van der Waals attractive force therebetween. An angle between the aligned directions of the carbon nanotubes in two adjacent carbon nanotube films can range from about 0 degrees to about 90 degrees. When the angle between the aligned directions of the carbon nanotubes in adjacent stacked carbon nanotube films is larger than 0 degrees, a plurality of micropores is defined by the carbon nanotube film. Stacking the carbon nanotube films will also add to the structural integrity of the carbon nanotube film.

The carbon nanotube film can be made by the steps of: growing a carbon nanotube array on a wafer by chemical vapor deposition method; and drawing the carbon nanotubes of the carbon nanotube array to from the carbon nanotube film. During the drawing step, the carbon nanotubes are joined end-to-end by van der Waals attractive force therebetween along the drawing direction. The carbon nanotube film has the smallest resistance along the drawing direction and the greatest resistance along a direction perpendicular to the drawing direction. Thus, the carbon nanotube film is resistance anisotropy. Furthermore, the carbon nanotube film can be etched or irradiated by laser. After being irradiated by laser, a plurality of parallel carbon nanotube conductive strings will be formed and the resistance anisotropy of the carbon nanotube film will not be damaged because the carbon nanotube substantially extending not along the drawing direction are removed by burning. Each carbon nanotube conductive string comprises a plurality of carbon nanotubes joined end-to-end by van der Waals attractive force.

When the transparent conductive layer 14 is a carbon nanotube layer, the plurality of sensing electrodes 16 is located on a side of the carbon nanotube layer, and the side is perpendicular to the orientation of the plurality of carbon nanotubes. Namely, the arrangement direction of the sensing electrodes 16 is perpendicular to the extending direction of the plurality of carbon nanotubes in the transparent conductive layer 14.

The adhesive layer 13 is configured to fix the transparent conductive layer 14 on the substrate 12. The adhesive layer 13 can be transparent. The adhesive layer 13 can be made of materials such as hot plastic or UV glue, for example PVC or PMMA. The thickness of the adhesive layer 13 can be in a range from about 1 nanometer to about 500 micrometers, for example, the thickness is in a range from about 1 micrometer to about 2 micrometers. In one embodiment, the adhesive layer 13 is a UV glue layer with a thickness of 1.5 micrometers.

The plurality of sensing electrodes 16 can be formed by conductive material, such as metal, conductive polymer, conductive adhesive, metallic carbon nanotubes, or indium tin oxide. The plurality of sensing electrodes 16 can be made by a method such as screen printing, chemical vapor deposition, or magnetron sputtering.

The conductive trace 18 can be made by a method such as screen printing, chemical vapor deposition, or magnetron sputtering. In one embodiment, the conductive trace 18 is formed concurrently by printing conductive silver paste. The conductive silver paste can include about 50% to about 90% (by weight) of the metal powder, about 2% to about 10% (by weight) of the glass powder, and about 8% to about 40% (by weight) of the binder.

When using the touch panel 10, a user often touches the center region of the touch panel 10, especially the first touch-view area 11. The second touch-view area is not often touched. Therefore, the distance between two adjacent sensing electrodes 16 can be unequal. The distance between the two adjacent sensing electrodes 16 on the second touch-view area is larger than the distance between the two adjacent sensing electrodes 16 on the first touch-view area 11. The number of the plurality of sensing electrodes 16 in per unit area of the first touch-view area 11 is greater than the number of the plurality of sensing electrodes 16 in per unit area of the second touch-view area.

The shortest touching distance formed by a finger of the user or a conductive material is related to the number of the plurality of sensing electrodes 16 in per unit area. The more sensing electrodes 16 in per unit area of the first touch-view area 11, the smaller the shortest touching distance by a finger of the user or a conductive material such that the sensitivity of the first touch-view area 11 is higher. Because the utilization rate of the second touch-view area is far lower than the utilization rate of the first touch-view area 11, it does not affect the overall use of the touch panel 10 even if the sensitivity of the second touch-view area is slightly lower. The sensitivity of the touch panel 10 is improved and overall size of the touch panel 10 is not increased.

Furthermore, in the case of not reducing the overall sensitivity of the touch panel 10, the total quantity of the plurality of sensing electrodes 16 can be reduced. As long as the number of the plurality of sensing electrodes 16 in per unit area of the first touch-view area 11 is unchanged, the number of the plurality of sensing electrodes 16 in per unit area of the second touch-view area can be reduced. Because the total quantity of the plurality of sensing electrodes 16 is reduced, the quantity of the conductive wires is accordingly reduced. So that, the area of the trace area 10B can be reduced.

Because the area of the trace area 10B can be reduced, when the overall size of the touch panel 10 is unchanged, the area of the touch-view area 10A can be increased. Because the area of the trace area 10B can be reduced, when the area of the touch-view area 10A is unchanged, the overall size of the touch panel 10 can be reduced.

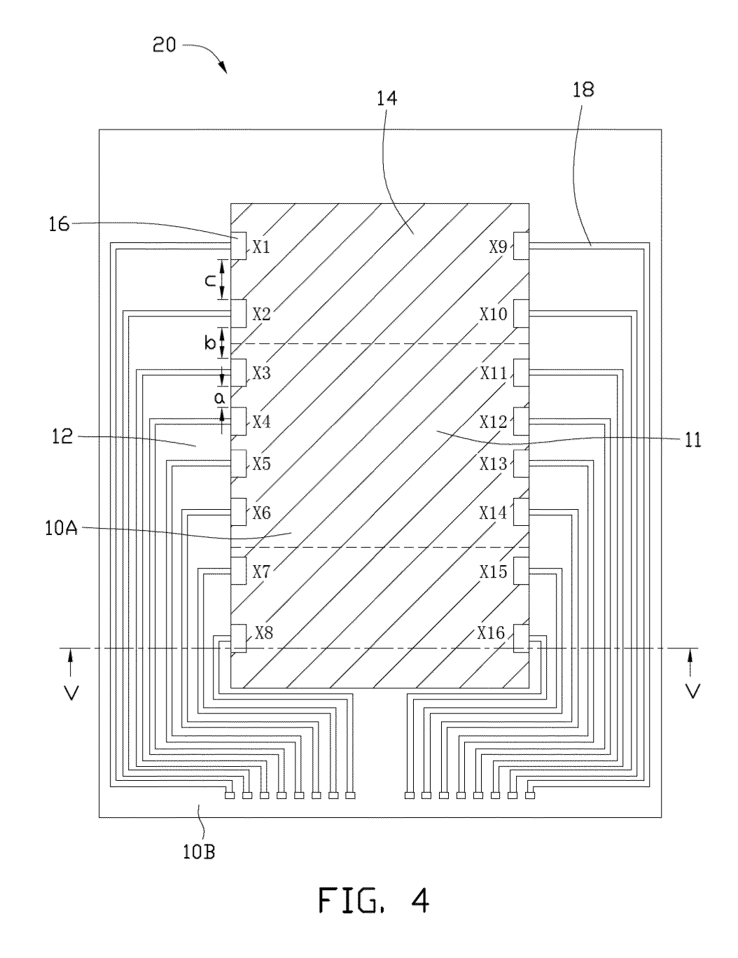

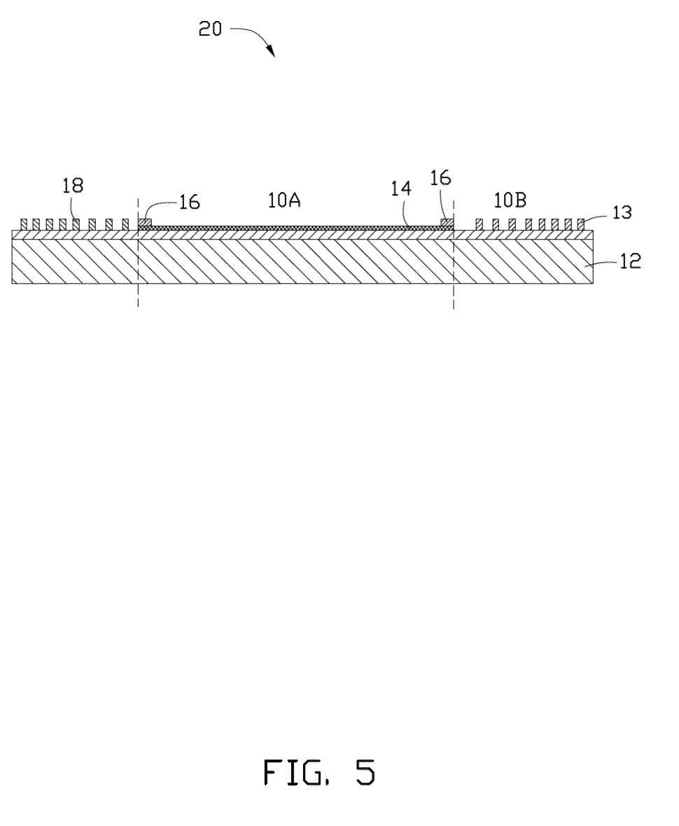

Referring to FIGS. 4 and 5, a touch panel 20 of another embodiment includes a substrate 12, an adhesive layer 13, a transparent conductive layer 14, a plurality of sensing electrodes 16, and a conductive trace 18. The transparent conductive layer 14 includes a first side and a second side that is opposite to and parallel to the first side. The plurality of sensing electrodes 16 is located on the first side and the second side of the transparent conductive layer 14. The plurality of sensing electrodes 16 is spaced from each other and electrically connected with the transparent conductive layer 14.

The touch panel 20 is similar to the touch panel 10. The difference between the touch panel 20 and the touch panel 10 is the location of the sensing electrodes 16. In the touch panel 20, the plurality of sensing electrodes 16 is located on two opposite sides of the transparent conductive layer 14 and spaced from each other.

In detail, in another embodiment, for example, there are eight first sensing electrodes 16 located on the first side of the transparent conductive layer 14. There are eight second sensing electrodes 16 located on the second side of the transparent conductive layer 14. The plurality of first sensing electrodes 16 is spaced from each other and the plurality of second sensing electrodes 16 is spaced from each other. The eight first sensing electrodes 16 are sequentially named as an electrode X1, an electrode X2, an electrode X3, an electrode X4, an electrode X5, an electrode X6, an electrode X7, and an electrode X8. The eight second sensing electrodes 16 are sequentially named as an electrode X9, an electrode X10, an electrode X11, an electrode X12, an electrode X13, an electrode X14, an electrode X15, and an electrode X16. A distance between the electrode X1 and electrode X2 is defined as c, a distance between the electrode X3 and electrode X2 is defined as b, a distance between the electrode X4 and electrode X3 is defined as a, wherein c>b>a. A distance between the electrode X6 and electrode X5 is defined as d, a distance between the electrode X7 and electrode X6 is defined as e, a distance between the electrode X8 and electrode X7 is defined as f, wherein f>e>d. A distance between the electrode X10 and electrode X9 is defined as g, a distance between the electrode X11 and electrode X10 is defined as h, a distance between the electrode X12 and electrode X11 is defined as i, wherein g>h>i. A distance between the electrode X14 and electrode X13 is defined as j, a distance between the electrode X15 and electrode X14 is defined as k, a distance between the electrode X16 and electrode X15 is defined as m, wherein m>k>j. In one embodiment, a=d=i=j, b=e=h=k, c=f=g=m. The number of the plurality of sensing electrodes 16 in per unit area close to the midline of the first touch-view area 11 is greater than the number of the plurality of sensing electrodes 16 in per unit area away from the midline of the first touch-view area 11. The closer the plurality of sensing electrodes 16 to the midline of the first touch-view area 11, the more intensive the plurality of sensing electrode 16.

When the transparent conductive layer 14 is a carbon nanotube layer, the plurality of sensing electrodes 16 is located on two opposite sides of the carbon nanotube layer. And the two opposite sides are perpendicular to the orientation of the plurality of carbon nanotubes.

In summary, the number of the plurality of sensing electrodes 16 per unit area in the first touch-view area 11 is greater than the number of the plurality of sensing electrodes 16 per unit area in the rest of the touch-view area 10A. Therefore, the sensitivity of the touch panel 10 is improved and overall size of the touch panel 10 is not increased. Moreover, in the case of not reducing the sensitivity of the touch panel 10, not changing the overall size of the touch panel 10 and increasing the area of the touch-view area 10A, or reducing the overall size of the touch panel 10 and not changing the area of the touch-view area 10A. In addition, the structure of the touch panel 10 or 20 is simple and easy to implement.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

What is claimed is:

1. A touch panel, comprising:
a substrate having a surface comprising a touch-view area and a trace area;
a transparent conductive layer located on the surface of the substrate;
a plurality of sensing electrodes electrically connected with the transparent conductive layer and spaced from each other;
a conductive trace located on the trace area;
wherein the touch-view area comprises a first touch-view area, and a density of sensing electrodes located on the first touch-view area is greater than a density of sensing electrodes located on other areas of the touch-view area.

2. The touch panel of claim 1, wherein a distance between two adjacent sensing electrodes is in a range from about 3 mm to about 15 mm.

3. The touch panel of claim 1, wherein the plurality of sensing electrodes is located on a side of the transparent conductive layer.

4. The touch panel of claim 1, wherein the plurality of sensing electrodes is located on two opposite sides of the transparent conductive layer.

5. The touch panel of claim 1, wherein a center region of the surface of the substrate is defined as the touch-view area, and a periphery area of the surface of the substrate is defined as the trace area.

6. The touch panel of claim 1, wherein the first touch-view area is located on a center region of the touch-view area.

7. The touch panel of claim 1, wherein the transparent conductive layer is selected from the group consisting of a carbon nanotube layer, a conductive indium tin oxide layer, and a conductive antimony tin oxide layer.

8. The touch panel of claim 7, wherein the carbon nanotube layer comprises a plurality of carbon nanotubes.

9. The touch panel of claim 8, wherein the plurality of carbon nanotubes is oriented along a same orientation.

10. The touch panel of claim 9, wherein the plurality of sensing electrodes is arranged along a direction that is perpendicular to the orientation of the plurality of carbon nanotubes.

11. The touch panel of claim 1, further comprising an adhesive layer to fix the transparent conductive layer on the surface of the substrate.

12. A touch panel, comprising:
a substrate having a surface comprising a touch-view area and a trace area;
a transparent conductive layer located on the surface of the substrate;
a plurality of sensing electrodes electrically connected with the transparent conductive layer;
a conductive trace located on the trace area;
wherein the plurality of sensing electrodes is spaced from each other with different distances between two adjacent sensing electrodes.

13. The touch panel of claim 12, wherein the touch-view area comprises a first touch-view area, a distance between two adjacent sensing electrodes away from a midline of the first touch-view area is larger than a distance between two adjacent sensing electrodes close to the midline of the first touch-view area.

14. The touch panel of claim 12, wherein the distance between two adjacent sensing electrodes increases gradually along a direction from a middle point of a side of the transparent conductive layer to each end of the side of the transparent conductive layer.

15. The touch panel of claim 12, wherein the plurality of sensing electrodes is located on two opposite sides of the transparent conductive layer.

16. The touch panel of claim 12, wherein a center region of the surface of the substrate is defined as the touch-view area, and a periphery area of the surface of the substrate is defined as the trace area.

17. The touch panel of claim 12, wherein the transparent conductive layer is selected from the group consisting of a carbon nanotube layer, a conductive indium tin oxide layer, and a conductive antimony tin oxide layer.

18. The touch panel of claim 17, wherein the carbon nanotube layer comprises a plurality of carbon nanotubes.

19. The touch panel of claim 18, wherein the plurality of carbon nanotubes is oriented along a same orientation.

20. The touch panel of claim 19, wherein the plurality of sensing electrodes is arranged along a direction that is perpendicular to the orientation of the plurality of carbon nanotubes.
